(19) United States
(12) Patent Application Publication
(10) Pub. No.: US 2001/0003538 A1
(43) Pub. Date: Jun. 14, 2001

(54) Telephone apparatus, Caller ID service handling apparatus, and communication system

(76) Inventor: Toshihiko Sakata, Fukuoka (JP)

Correspondence Address: McDERMOTT, WILL & EMERY, 600 13th Street, N.W., Washington, DC, 20005-3096, US

(21) Appl. No.: 09/725,172

(22) Filed: Nov. 29, 2000

(30) Foreign Application Priority Data
Nov. 29, 1999 (JP) 11-337135

(51) Int. Cl. H04M 3/00; H04M 5/00

(52) U.S. Cl. 379/142; 379/283

(57) ABSTRACT

A Caller ID service handling apparatus capable of upgrading and coping flexibly with change of service contents and addition of service. This apparatus has a program memory region in its memory so as to be flexibly applied to the service contents. The communication format of the exchange equipment and this apparatus is determined. The exchange equipment transmits a program corresponding to change or addition of service contents. This apparatus downloads necessary data. Thus, without requiring exclusive apparatuses individually, in spite of service contents differing corresponding to change in Caller ID service content, addition of new Caller ID service, or difference in service contents among telephone companies (carriers), it presents an apparatus capable of upgrading.

### FIELD OF THE INVENTION

The present invention relates to an apparatus having a Caller ID service handling function, a telephone apparatus, and a communication system.

### BACKGROUND OF THE INVENTION

Recently, the caller identification (Caller ID) service is rapidly spreading around the world.

Caller ID service Type 1 and Type 2 have been one-way services telling only the caller's telephone number, name, and incoming time.

In Caller ID service Type 2.5 and Type 3, the telephone company (carrier) has started to present two-way services capable of processing received telephone calls in various manners. Contents and names of such services differs from one telephone company to other.

A conventional telephone apparatus is explained below while referring to the drawings.

FIG. 4 is a block diagram of a conventional Caller ID service handling apparatus 31. The apparatus 31 comprises a network interface 32, a modem 33 for detecting Frequency Shift Keying (FSK) signal or Caller identification Alert Signal (CAS) signal, a DTMF signal generator 34 for returning a Digital Tone Multi-Frequency (DTMF) signal as an Acknowledgement (ACK) signal to the exchange equipment, a host CPU 35 for controlling the system, a memory 36 for storing the data acquired by the apparatus through the Caller ID service, and a display unit 37 for displaying the caller information acquired through the caller ID service.

FIG. 5 is a composition diagram of a Caller ID section of the conventional apparatus. FIG. 5 shows an example of Caller ID handling apparatus 41, an operation section 42 for selecting service contents, and a Caller ID data display section 43.

In the conventional Caller ID handling apparatus having such configuration, the operation is explained below.

The exchange equipment sends out a CAS signal, and notices the Caller ID service handling apparatus that the exchange equipment transmits Caller ID data. The apparatus detects the CAS signal in the modem 33, and returns the DTMF signal as the ACK signal to the exchange equipment by the DTMF generator 34.

Consequently, using the FSK signal, the exchange equipment sends out Caller ID data. The apparatus 31 detects the FSK signal at the modem 33, and takes in the Caller ID data, and accumulates in the memory 36, and also displays the Caller ID data in the display unit 37 at the same time.

Further, the apparatus 31 selects a service corresponding to the caller from the existing services presented by the telephone company (carrier), and when the select key is pressed in the service content select operation section 42, the apparatus sends out the DTMF signal to the exchange equipment from the DTMF generator 34. At this time, the exchange equipment recognizes the selected service, and presents to the apparatus 31.

In the conventional method, however, in relation to change in Caller ID service content, addition of new Caller ID service, or differences in service contents among telephone companies (carriers), different Caller ID handling apparatuses were needed individually. That is, when a new service is presented by the telephone company, a new apparatus needs to be developed. The user hence needed a new apparatus for receiving a new service.

### SUMMARY OF THE INVENTION

In the light of the above problems, therefore, it is an object of the invention to present a telephone apparatus, a Caller ID service handling apparatus, and a communication system capable of upgrading to catch up with an addition of service, flexibly coping with changes in service contents, not requiring to develop the apparatuses individually, in correspondence to change in Caller ID service content, addition of new Caller ID service, or difference in service contents among telephone companies (carriers).

The telephone apparatus or Caller ID service handling apparatus of the invention comprises a modem for receiving FSK signal and CAS signal to cope with the Caller ID service from the exchange, a DTMF generator for returning a DTMF signal as ACK signal to the exchange, a display section of service contents, a memory for storing service data and storing operation parameters, and an operation section for selecting service.

Herein, the Caller ID service handling apparatus has a program memory region for downloading a program relating to a new service received from the exchange so as to cope flexibly with the service contents. A communication format between the exchange equipment and this apparatus is set. The exchange equipment transmits a program corresponding to the change or addition of the service contents. The Caller ID service handling apparatus downloads necessary data. Thus, the apparatus realizes a function corresponding to the changes in Caller ID service.

Further, the name of the select key of the service contents select operation section is not fixed. By the LCD display device capable of changing the display depending on the downloaded program, the display of the select key name is changed.

Thus, according to the invention:

1) It is not necessary to develop exclusive apparatuses individually corresponding to change in Caller ID service content, addition of new Caller ID service, or difference in service contents among telephone companies (carriers).

2) A Caller ID service handling apparatus capable of upgrading to catch up with an addition of service, flexibly coping with changes in service contents is presented.

### BRIEF DESCRIPTION OF THE DRAWINGS

FIG. 1 is a block diagram of principal parts of a Caller ID service handling apparatus in embodiment 1 of the invention.

FIG. 2 is a block diagram of the Caller ID service handling apparatus in embodiment 1 of the invention.

FIG. 3 is a schematic diagram of a communication system in embodiment 2 of the invention.

FIG. 4 is a block diagram of a conventional Caller ID service handling apparatus.

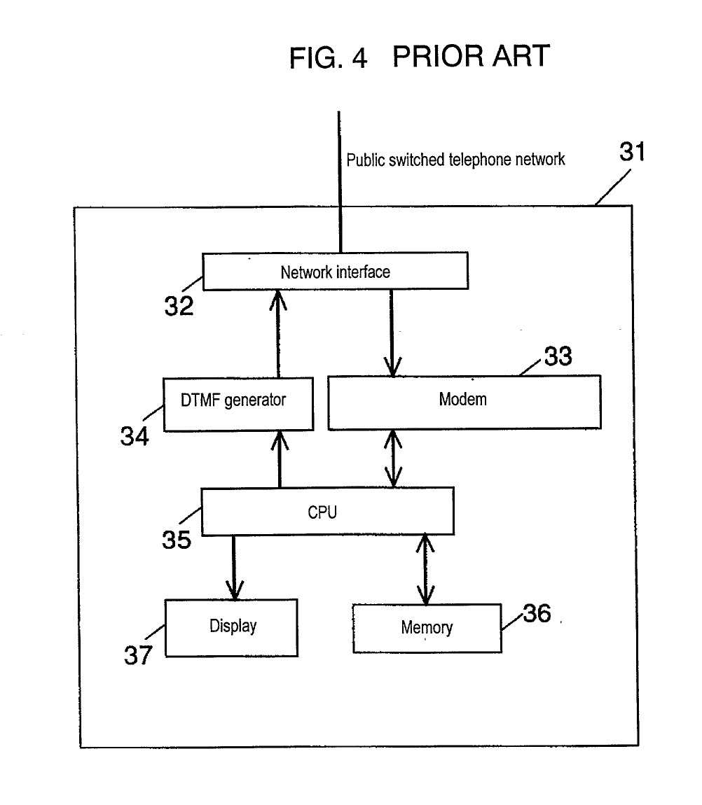

FIG. 5 is a composition diagram of a Caller ID section of the conventional apparatus.

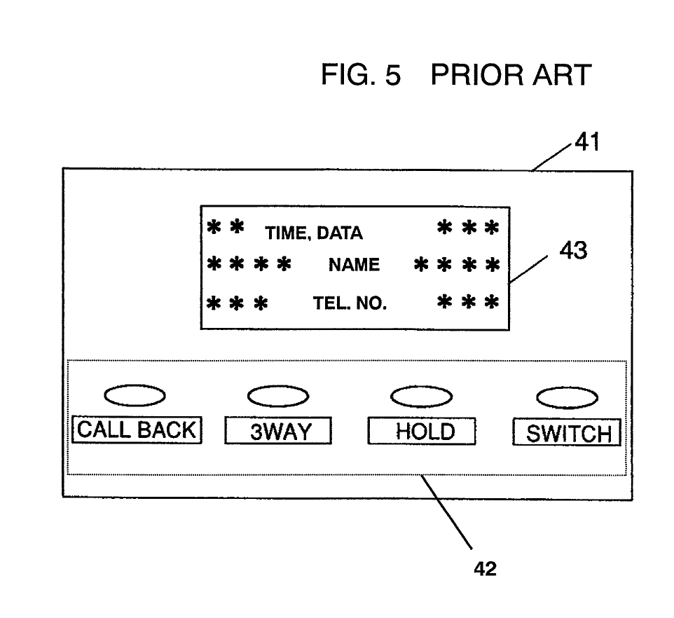

### DESCRIPTION OF THE PREFERRED EMBODIMENTS

Preferred embodiments of the invention are described in detail below while referring to the accompanying drawings.

### Embodiment 1

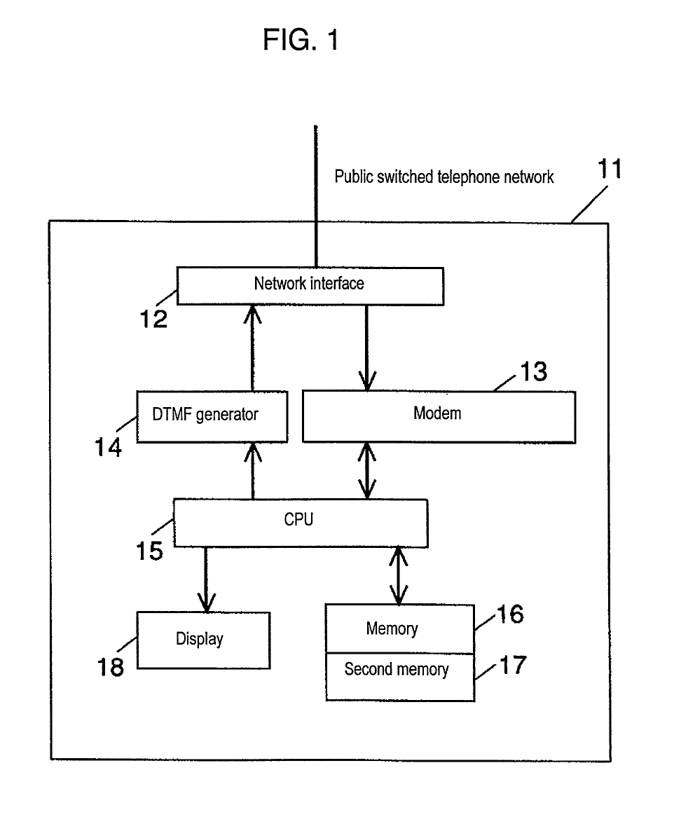

In FIG. 1, a Caller ID service handling apparatus 11 comprises a network interface 12, a modem 13 for detecting FSK signal or CAS, a DTMF generator 14 for returning a DTMF signal as ACK signal to the exchange equipment, a host CPU 15 for controlling the system, a memory 16 for storing the data acquired by the apparatus through the Caller ID service, a second memory 17 for storing a program for changing the function depending on the type of Caller ID service, and a display section 18 for displaying the caller information acquired through the Caller ID service and the service contents presented by the telephone company (carrier).

The Caller ID service handling apparatus 11 may be also installed separately as an adapter to an ordinary telephone set. Or the Caller ID service handling apparatus 11 may be incorporated in the telephone set.

If the Caller ID service handling apparatus 11 is provided in the telephone set, the display section 18 may be used commonly as the display of the telephone set.

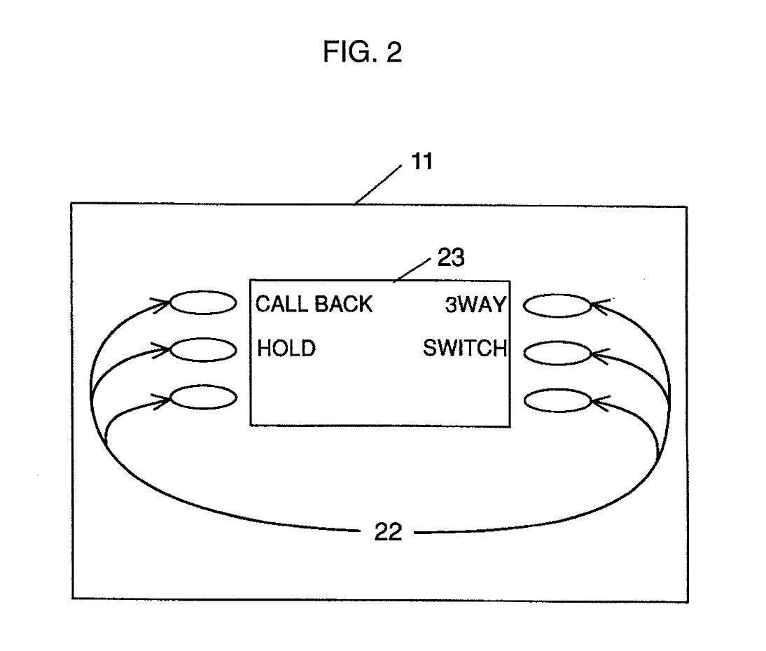

FIG. 2 is a block diagram of the Caller ID service handling apparatus in embodiment 1 of the invention.

In FIG. 2, the Caller ID service handling apparatus 11 includes an operation key 22 for selection of service contents and a display section 23. The display section 23 shows the contents of Caller ID service, that is, Call Back, Three-way (mini-conference), etc.

As shown in the drawing, the operation key 22 is disposed adjacently to the display section 23. At the position corresponding to the service content displayed in the display section 23, each button is disposed as operation key 22.

The operation of the Caller ID service handling apparatus in embodiment 1 of the invention is explained below.

The telephone company (carrier) transmits data by FSK signal for changing or adding the Caller ID service contents. At this time, the apparatus 11 can receive this FSK signal whether in on-hook state or in off-hook state. However, the exchange equipment is in on-hook state and can judge the state of this apparatus. Therefore, basically it is reasonable to transmit the data while this apparatus is in on-hook state.

As for the FSK signal sent from the exchange equipment and the communication format of transmission signal from the DTMF generator 14 of the apparatus 11, their communication methods are preliminarily determined.

The apparatus 11 receives the FSK signal by the modem 14, demodulates, and downloads the data. The data is read by the host CPU 15, and the contents in the second memory 17 storing the operation and display contents are rewritten and stored again.

The data includes, for example, service data showing the service contents, and operation parameters for operation of the apparatus corresponding to each service.

The data may further include data and a program for controlling rewriting or change of the memory in the apparatus 11.

Basically, at the Caller ID service handling apparatus side, the selection of the service is noticed to the exchange by the DTMF signal. All processing corresponding to the subsequent service is done at the exchange side. Therefore, on the occasion of change or addition of Caller ID service contents, the transmission side's action about a change of the apparatus side to be done by the FSK signal is only the change of the DTMF signal to be sent out by the apparatus 11 and service content display of the LCD display section 23 with the dot matrix LCD display.

Herein, by changing the operation parameter mentioned above, the DTMF signal can be changed. Or, by changing the service data, the service content display can be changed.

Thus, according to the embodiment, concerning service contents different corresponding to change in Caller ID service content, addition of new Caller ID service, or differences in service contents among telephone companies (carriers), it is not necessary to develop exclusive apparatuses individually. It further presents an apparatus capable of upgrading to catch up with addition of service by flexibly coping with changes in service contents.

### Embodiment 2

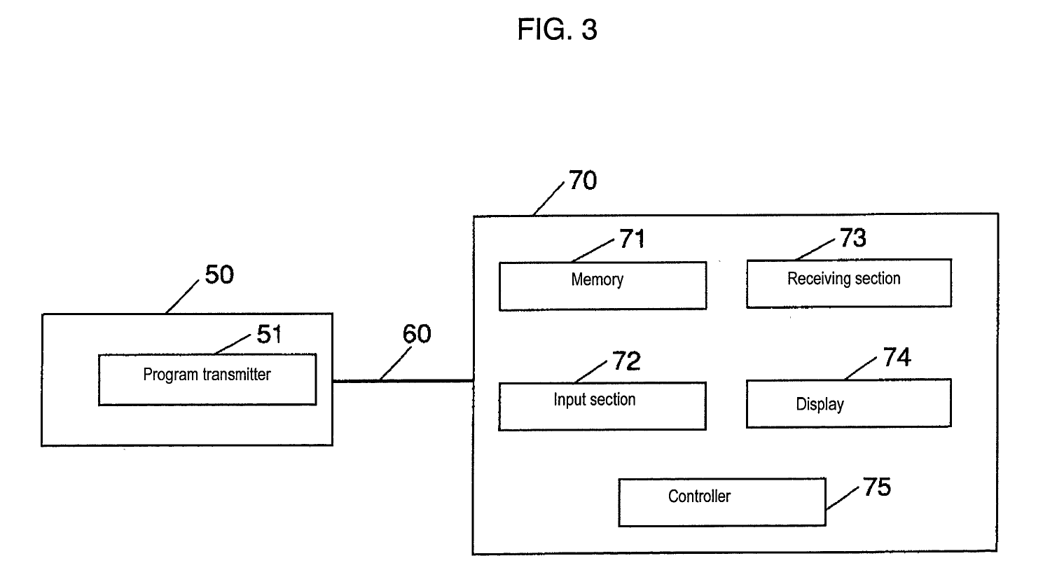

FIG. 3 is a schematic diagram of a communication system in embodiment 2 of the invention. In the diagram, an exchange 50 includes a program transmitter 51 for transmitting the new or update service to be presented as program data.

In FIG. 3, a network 60 connects between the exchange 50 and a telephone apparatus 70 described below.

In the telephone apparatus 70, a memory 71 stores program data to be transmitted from the exchange 50. The memory 71 is programmable to cope with subsequent updating or addition of service program. An input section 72 selects service contents. A receiving section 73 receives program data transmitted from the exchange 50 through the network 60.

A display section 74 displays the service contents. The display section 74 can also change the display depending on the service contents being updated or newly added.

When the exchange 50 transmits the program data which includes the data about new or update service, a controller 75 controls the entire telephone apparatus 70, and also operates as follows.

The telephone company (carrier) transmits the data for changing or adding the Caller ID service contents, by the FSK signal, from the exchange 50.

At this time, the telephone apparatus 70 can receive this FSK signal whether in on-hook state or in off-hook state. However, the exchange equipment can judge the state of this apparatus when this apparatus is in on-hook state. Basically, therefore, it is appropriate for the exchange to operate to transmit the above data while this apparatus is in on-hook state.

As for the communication format of the signal sent from the exchange 50 and the transmission signal by the telephone apparatus 70, the communication method is preliminarily determined.

The telephone apparatus 70 downloads the program data by the receiving section 73, and the data is read by the controller 75, and the contents in the memory 71 storing the operation and display contents are rewritten and stored again depending on the program data.

This program data may include i) service data and ii) operation parameters mentioned in embodiment 1. In other words, the program data includes:

1) Data for changing or adding the DTMF signal sent out by the apparatus,

2) Data for changing or adding the display of service contents, and

3) A program for controlling rewriting of memory contents or the like in order to add or change the data of 1) and 2).

Basically, at the Caller ID service handling apparatus (telephone apparatus) side, the service is selected by the DTMF signal. All processing corresponding to the subsequent service is done at the exchange 50 side. Therefore, on the occasion of change or addition of Caller ID service contents, the changes of the apparatus side to be done by the FSK signal sent from the transmission side are only i) the DTMF signal to be sent out by the telephone apparatus 70, and ii) the change of service content display of the display section 74 by the dot matrix LCD display.

Thus, according to the embodiment, concerning service contents different corresponding to change in Caller ID service content, addition of new Caller ID service, or difference in service contents among telephone companies (carriers), it is not necessary to develop exclusive apparatuses individually. It further presents an apparatus capable of upgrading to catch up with addition of service by flexibly copying with changes in service contents.

What is claimed is:

1. A telephone apparatus including a telephone set, handling Caller ID service, comprising:
a) a modem for receiving at least Frequency Shift Keying (FSK) signal relating to the Caller ID service and Caller identification Alert Signal (CAS) signal from the exchange;
b) a Digital Tone Multi-Frequency (DTMF) generator for returning an Acknowledgement (ACK) signal showing reception of at least one of the FSK signal and CAS signal to the exchange;
c) a service content display section for displaying the service contents of the Caller ID service;
d) a memory for storing service data and operation parameters for service of the Caller ID service received from the exchange; and
e) a service select operation section for selecting the service to be presented from the Caller ID service.

2. The telephone apparatus of claim 1,
wherein the service content display section is used commonly with the display of the telephone set.

3. The telephone apparatus of claim 1,
wherein the service select operation section is disposed adjacently to the service contents display section.

4. The telephone apparatus of claim 1,
wherein the service select operation section is disposed at a position corresponding to the service content displayed in the service content display section.

5. A Caller ID service handling apparatus from the exchange, comprising:
a) a modem for receiving at least Frequency Shift Keying (FSK) signal relating to the Caller ID service and Caller identification Alert Signal (CAS) signal from the exchange;
b) a Digital Tone Multi-Frequency (DTMF) generator for returning an Acknowledgement (ACK) signal showing reception of at least one of the FSK signal and CAS signal to the exchange;
c) a service content display section for displaying the service contents of the Caller ID service;
d) a memory for storing service data and operation parameters for service of the Caller ID service received from the exchange; and
e) a service select operation section for selecting the service to be presented from the Caller ID service.

6. The Caller ID service handling apparatus of claim 5,
wherein the service select operation section is disposed adjacently to the service contents display section.

7. The Caller ID service handling apparatus of claim 5,
wherein the service select operation section is disposed at a position corresponding to the service content displayed in the service content display section.

8. A communication system including an exchange having a program transmitter for transmitting a service to be presented to a terminal device as a program, and the terminal device connected to the exchange through a telephone line, said terminal device comprising:
a) a network interface connected to the telephone line;
b) a programmable memory for storing the program for executing the service;
c) an input section for specifying the service to be presented; and
d) a display section capable of changing the display contents for displaying the service contents,
wherein when the exchange updates or adds the service, the program transmitter transmits new program data, and corresponding to this action, the terminal device:
i) stores the new program data transmitted from the exchange in the memory, by updating or adding in the memory, and
ii) changes the display of the display section according to the service content, corresponding to the new program data.

9. The communication system of claim 8,
wherein the input section is adjacent to the display section, and disposed corresponding to the content of the service to be displayed.

10. The communication system of claim 8,
wherein the program includes the control program for changing the Digital Tone Multi-frequency (DTMF) signal transmitted from the terminal device, and the service contents displayed in the display section.

11. The telephone apparatus of claim 1,
wherein the operation parameter includes a parameter for controlling the DTMF generator to generate a DTMF signal depending on the service content.

12. The Caller ID service handling apparatus of claim 5,
wherein the operation parameter includes a parameter for controlling the DTMF generator to generate a DTMF signal depending on the service content.

13. The telephone apparatus of claim 1,
wherein the operation parameter includes a control program for changing the DTMF signal generated by the DTMF generator and the service content displayed in the display section.

14. The Caller ID service handling apparatus of claim 5,
wherein the operation parameter includes a control program for changing the DTMF signal generated by the DTMF generator and the service content displayed in the display section.
